(19) United States
(12) Patent Application Publication
(10) Pub. No.: US 2004/0255104 A1
(43) Pub. Date: Dec. 16, 2004

(54) Method and apparatus for recycling candidate branch outcomes after a wrong-path execution in a superscalar processor

(75) Inventors: Haitham H. Akkary, Portland, OR (US); Srikanth T. Srinivasan, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 10/460,862

(22) Filed: Jun. 12, 2003

(51) Int. Cl. G06F 9/44

(52) U.S. Cl. 712/239

(57) ABSTRACT

A method and apparatus for recycling wrong-path branch outcomes in a superscalar single-threaded processor is disclosed. In one embodiment, a branch recycling predictor may be used to determine whether a speculatively executed branch instruction's outcome, coming at the end of a wrong-path branch, may be a better prediction than that given by a traditional branch predictor. In one embodiment, the branch recycling predictor may correlate the previous wrong-path branch outcomes with the previous correct-path branch outcomes. The history of the traditional branch predictor may also be used. The branch recycling predictor may be used to choose between using the traditional branch predictor's prediction, or instead using the wrong-path branch outcome.

### FIELD

The present disclosure relates generally to microprocessor systems, and more specifically to microprocessor systems capable of speculative single-threaded execution using branch prediction.

### BACKGROUND

In order to enhance the processing throughput of microprocessors, processors capable of speculative single-threaded execution may speculatively execute past a predicted branch point. When a branch is executed and is later found to be mispredicted, the processor has to flush all those instructions that have been fetched or executed from the mispredicted “wrong path”. The processor then has to restart the fetch from the correct point in the program after the branch instruction.

On many high performance processors, due to a potentially very long delay from the time a branch is mispredicted until it is executed, the processor may fetch and execute a very large number of instructions that are wasted, since none of these instructions may necessarily be needed or correct. It would be very desirable if the results of some of the instructions executed from the wrong path could be reused later during the non-speculative execution after the branch misprediction is corrected. In particular, it may be desirable that reusable outcomes of branches from the wrong path could be saved for use in the non-speculative execution after the branch misprediction is corrected.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram of superscalar processor capable of speculative execution, according to one embodiment.

FIG. 2 is a diagram of wrong-path and correct-path execution in a series of basic blocks, according to one embodiment.

FIG. 3 is a schematic diagram of a branch outcome recycling circuit, according to one embodiment of the present disclosure.

FIG. 4 is a schematic diagram of a branch recycling predictor of FIG. 3, according to one embodiment of the present disclosure.

FIG. 5A is a diagram of a state machine set of FIG. 4, according to one embodiment of the present disclosure.

FIG. 5B is a logic table of a counter of FIG. 5A, according to one embodiment of the present disclosure.

FIG. 6 is a flowchart of determining how to train a branch recycling predictor, according to one embodiment of the present disclosure.

FIG. 7 is a schematic diagram of a multi-processor system, according to another embodiment of the present disclosure.

### DETAILED DESCRIPTION

The following description describes techniques for determining whether a processor's non-speculative execution should either follow a branch outcome determined by the processor's branch predictor, or that it should instead follow a branch path determined by a speculative execution on a wrong-path with respect to a previous branch misprediction. In the following description, numerous specific details such as logic implementations, software module allocation, bus signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. The invention is disclosed in the form of a superscaler processor, such as the Pentium 4® class machine made by Intel® Corporation. However, the invention may be practiced in other forms of processors capable of speculative execution.

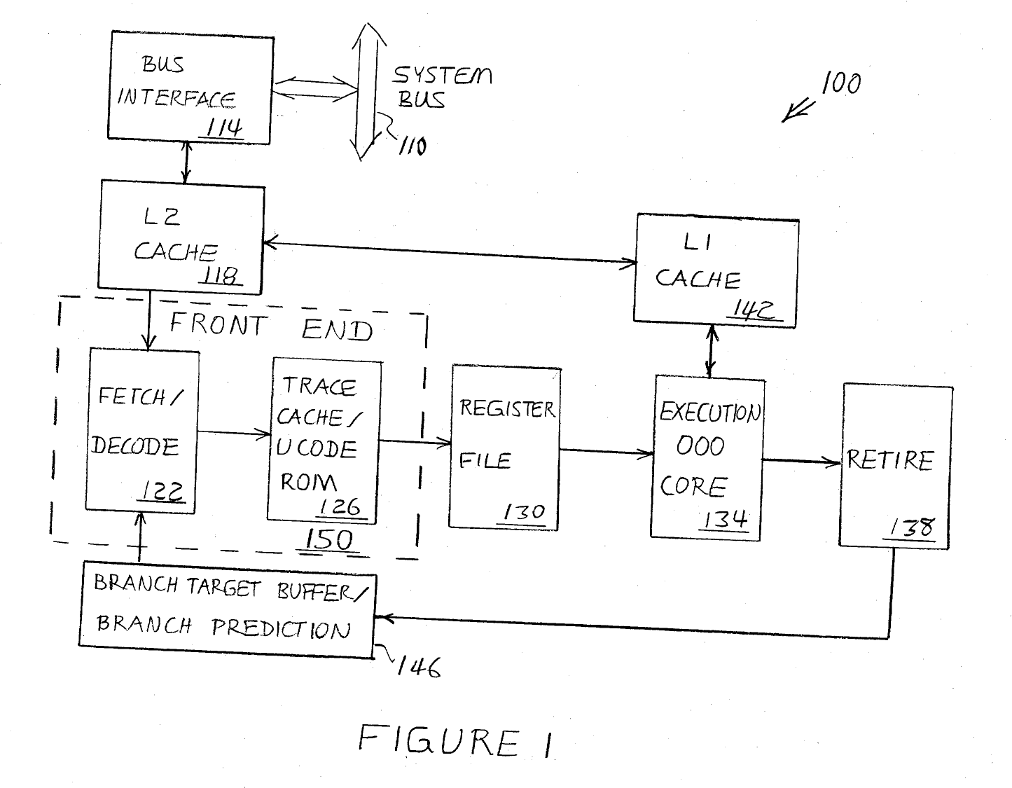

Referring now to FIG. 1, a schematic diagram of superscalar processor 100 capable of speculative execution is shown, according to one embodiment. Processor 100 may have a bus interface 114 for connecting with a system bus 110. Instructions and data may be received from memory and placed into a level two (L2) cache 118 and subsequently into a level one (L1) cache 142. Processor 100 may have a front end 150 including a fetch/decode stage 122 and a trace cache/microcode read-only-memory (ROM) stage 126. The front end 150 may set up the register file 130 for use in out-of-order (OOO) execution in the execution OOO core 134. Subsequent to the execution in execution OOO core 134, the instructions are retired in retirement stage 138.

Speculative execution in processor 100 should not commit its results to the register file 130, or to system memory. Instead, the processor 100 may accumulate the results of speculative execution. In one embodiment, the retirement stage 138 may send such results to a branch target buffer/branch prediction stage 146 which may then place the results of speculative execution into front end 150. The results may then be available for reuse during non-speculative execution in processor 100.

The functional modules shown within the processor 100 are representative of functional modules generally found in superscalar processors. In other embodiments, processor 100 may include different functional modules than those shown in FIG. 1.

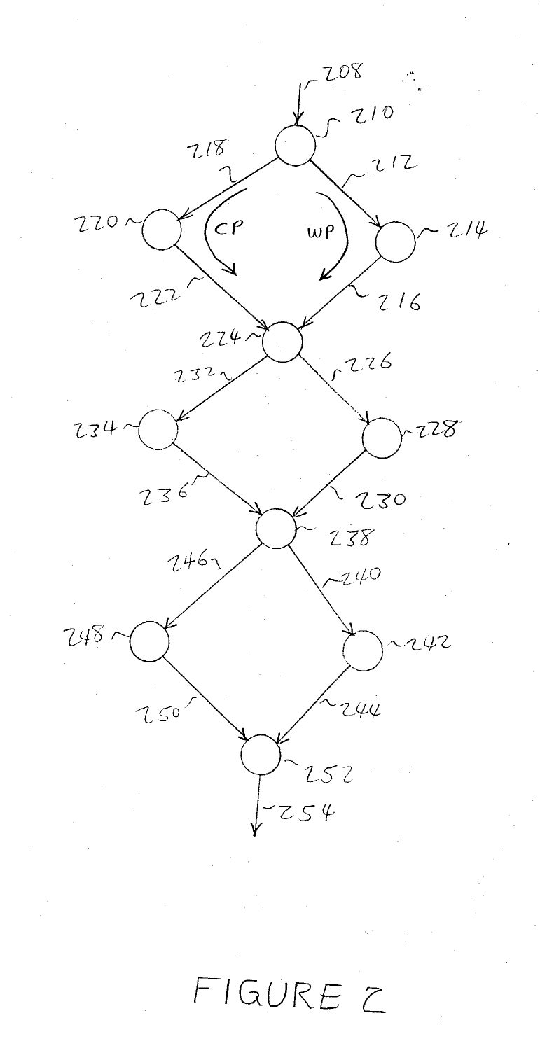

Referring now to FIG. 2, a diagram of wrong-path and correct-path execution in a series of basic blocks is shown, according to one embodiment. For the sake of simplicity, a single thread program in shown, but in other embodiments multiple threads could be used. FIG. 2 is a simplified drawing showing “basic blocks” of code, where basic blocks 210, 214, 220, 224, through 252 have a single entry point and a single (possibly branched) exit point. Certain of the basic blocks may exist at locations where the single entry point is at the convergence of two or more branches. These may be called convergence points 224, 238, 252.

When the code shown in FIG. 2 is speculatively executed, it is possible that certain branch instructions may, upon execution, give incorrect results. The reason for this is that the registers giving the operands for the branch instructions may contain different values than the values present during non-speculative execution. A mispredicted branch may be defined to include branches taken incorrectly due to speculative execution that is later found to be incorrect during non-speculative execution. The path taken subsequent to a mispredicted branch may be called a wrong-path, in distinction to a correct-path determined by the execution of a branch instruction during subsequent non-speculative execution.

In one example, during speculative execution there may be a mispredicted branch at the end of basic bloc 210, causing speculative execution to proceed down wrong path 212, 214, 216. The branch at the end of basic block 224 may or may not be correctly calculated during speculative execution. Whether or not the branch outcome at the end of basic block 224 is correctly calculated during speculative execution, it may (due to its location) be called a wrong-path branch outcome. Without additional investigation, it may not be clear whether or not a wrong-path branch outcome is correct. During a subsequent non-speculative execution down the correct-path 218, 220, 222 additional information may be needed to determine whether the wrong-path branch outcome may be a better predictor of non-speculative execution of the “candidate branch” at the end of basic block 224 than the prediction given by a standard branch predictor. When it is determined that the wrong-path branch outcome is preferred, it may be “recycled” to predict the non-speculative branch execution outcome.

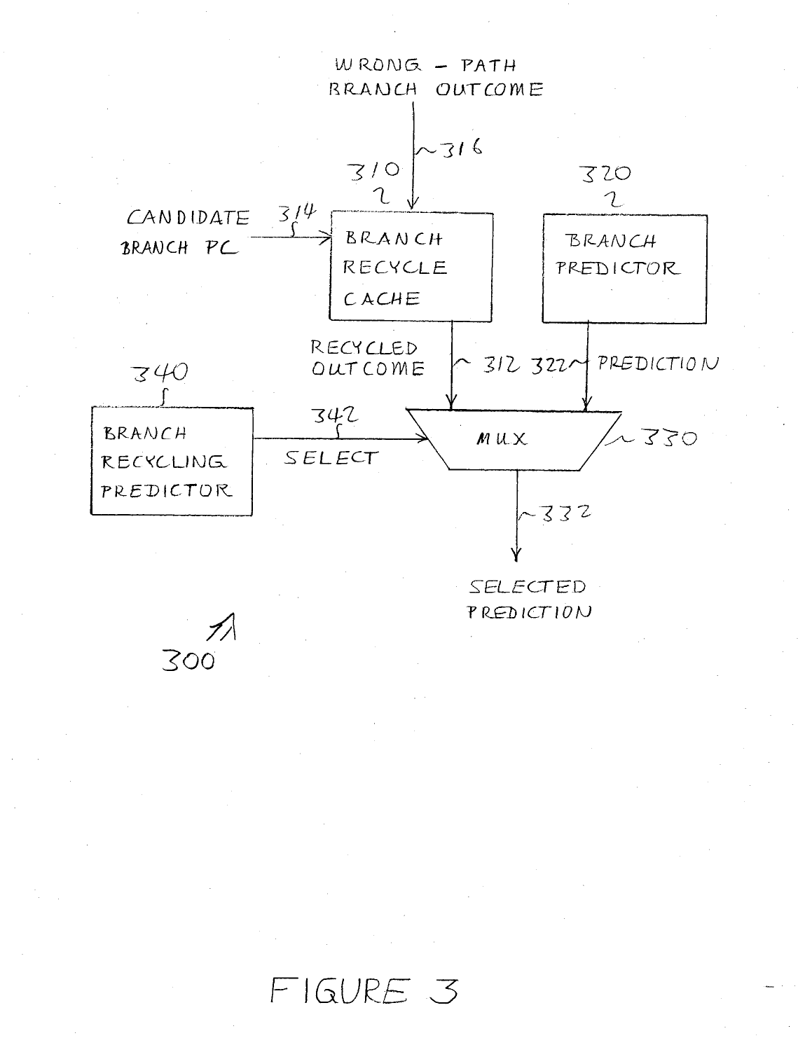

Referring now to FIG. 3, a schematic diagram of a branch outcome recycling circuit is shown, according to one embodiment of the present disclosure. In one embodiment, branch outcome recycling circuit 300 may include a branch recycling cache 310, a standard branch predictor 320, and a branch recycling predictor 340. The branch predictor 320 may be one of various well-known branch predictor circuits, implementing the well-known pad or gshare branch prediction algorithms. In other embodiments, other branch prediction algorithms may be used.

Branch recycle cache 310 may be used to store the wrong-path branch outcomes arriving on wrong-path branch outcome signal line 316. Branch recycling cache 310 may be implemented using a wide variety of memory architectures, including fully associative, set associated, and column associative. In one embodiment, an implicitly ordered set associative cache may be used. In this embodiment, the entries in a set may be handled as if they were a circular buffer. Wrong-path branch outcomes may be addressed by the candidate branch program counter value on candidate branch program counter signal line 314. In other embodiments, the outcomes may be addressed by candidate branch program counter values in light of various global or local execution histories. A selected wrong-path branch outcome may be presented to a mux 330 which selects either a wrong-path branch outcome on recycled outcome signal line 312 or a prediction from branch predictor 320 on prediction signal line 322. In other embodiments, other forms of switches than mux 330 may be used.

In branch recycle cache 310 it may be possible in some embodiments to maintain wrong-path branch outcomes from multiple wrong-path executions. In one embodiment, only the wrong-path branch outcomes of the immediately previous mispredicted branch may be stored in branch recycle cache 310. Because the branch recycle cache 310 may be allocated at fetch, considerably before a branch misprediction is detected, all executed branches on the correct-path as well as on the wrong-path may be allocated entries in the branch recycle cache 310. However, only the mispredicted branch outcomes may be used. For this reason, there may be two buffers in the branch recycle cache 310. One may hold the branch outcomes from the most recent wrong-path branch that was currently recycled. The other may be used to allocated new entries and store new branch outcomes in preparation for the next branch misprediction and wrong-path to recycle.

Branch recycling predictor 340 may be used to determine whether the wrong-path branch outcome supplied by branch recycling cache 310 may be a better predictor of non-speculative execution of the candidate branch than the prediction given by branch predictor 320. When it does, branch recycling predictor 340 may signal this via select signal line 342 or its equivalent. Branch recycling predictor 340 may make its selection based upon various combinations of global or local execution history, along with current results of speculative or non-speculative execution.

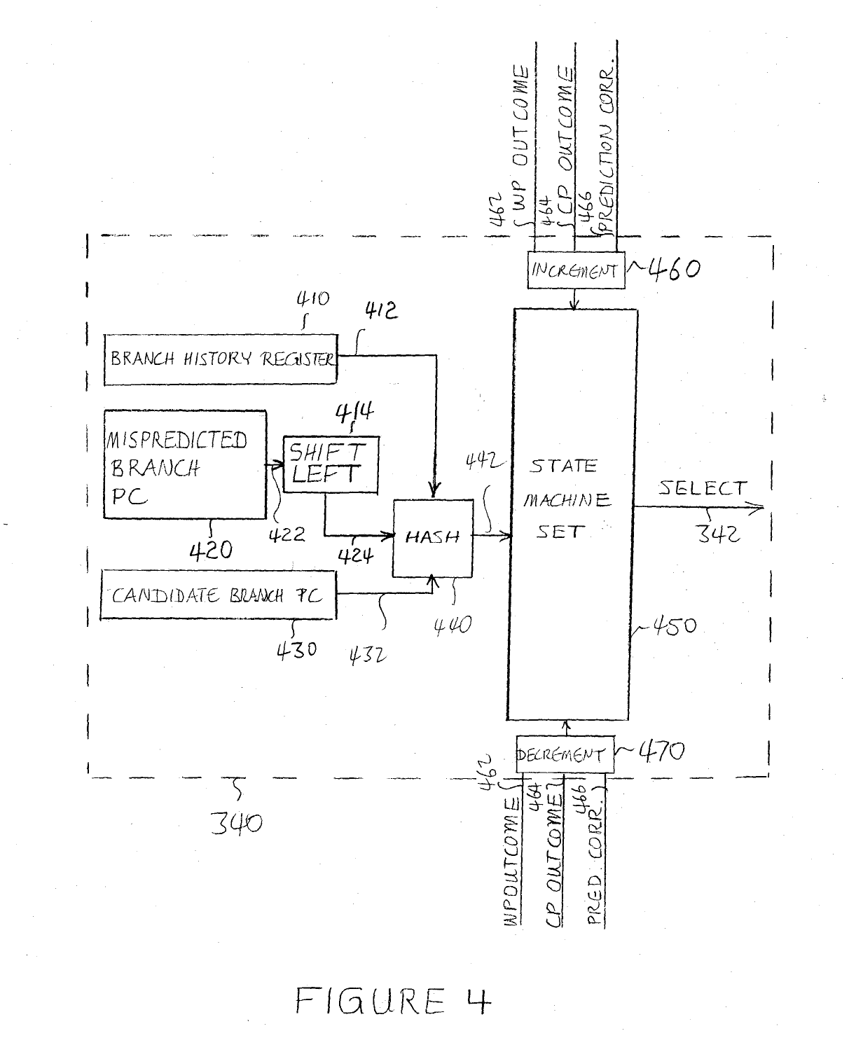

Referring now to FIG. 4, a schematic diagram of a branch recycling predictor 340 of FIG. 3 is shown, according to one embodiment of the present disclosure. In the FIG. 4 embodiment, a state machine set 450 includes individual state machines that may be trained by the ongoing speculative and non-speculative execution of the various branch instructions within program code. In this manner the branch recycling predictor 340 may determine the correlation between the previous wrong-path branch outcomes and the previous correct-path branch outcomes.

The individual state machines could be selected (indexed) by the program counter of the candidate branch under consideration. In some embodiments, the indexing could be performed with combinations of candidate branch program counters and either global or local execution history. In the FIG. 4 embodiment, the indexing includes the contributions of the candidate branch program counter value, which may be stored in a candidate branch program counter register 430, a mispredicted branch program counter value, which may be stored in a mispredicted branch program counter register 420, and a listing of recent branch execution outcomes, which may be stored in a branch history register 410. In other embodiments, the listing of recent branch execution outcomes may be replaced with a measure of the distance between the current branch and the last occurrence of a misprediction. These may be combined in various ways to produce an index for the state machine set 450. In one embodiment, mispredicted branch program counter register 420 may store M bits of the mispredicted branch program counter value, branch history register 410 may store M bits of branch history, and candidate branch program counter register 430 may store M bits of the candidate branch program counter value. The M bits of the mispredicted branch program counter value may be offset to form an offset mispredicted branch program counter value. In one embodiment, the mispredicted branch program counter register 420 sends the mispredicted branch program counter value to a shift left module, where the M bits of the mispredicted branch program counter value are left-shifted N bits to form the offset mispredicted branch program counter value. Then the offset mispredicted branch program counter value, the branch history value from branch history register 410, and the candidate branch program counter value from candidate branch program register 430 may be hashed in hash logic 440 to form an index on index signal path 442 to the state machine set 540. The shift left logic 414 and hash logic 440 may be implemented using a variety of logic elements and algorithms. In one embodiment, hash logic 440 may implement an EXCLUSIVE OR logic. In other embodiments, other well-known hashing algorithms may be used, and the offset may be derived by other methods than by shifting to the left a fixed number of bits.

In one embodiment, state machine set 450 may include counters as the individual state machines. The counters may be incremented by increment logic 460 and may be decremented by decrement logic 470. Various combinations of speculative and non-speculative execution history and other factors may be utilized in determining when to increment or decrement the counters. In one embodiment, increment logic 460 may increment an indexed counter when a wrong-path branch outcome on WP outcome signal path 462 equals the correct-path branch outcome on CP outcome signal path 464. The determination to increment may also require that a branch prediction of branch predictor 320 be incorrect as signaled on predictor correct signal path 466. In this manner the history of the previous wrong-path branch outcomes and previous correct-path branch outcomes may be correlated. The resulting value contained within the indexed counter may be used to determine whether the wrong-path branch outcomes and previous correct-path branch outcomes may be determined to be correlated. If they are determined to be correlated, then a select signal on select signal path 342 may be generated to select a wrong-path branch outcome stored in the branch recycle cache as the selected prediction.

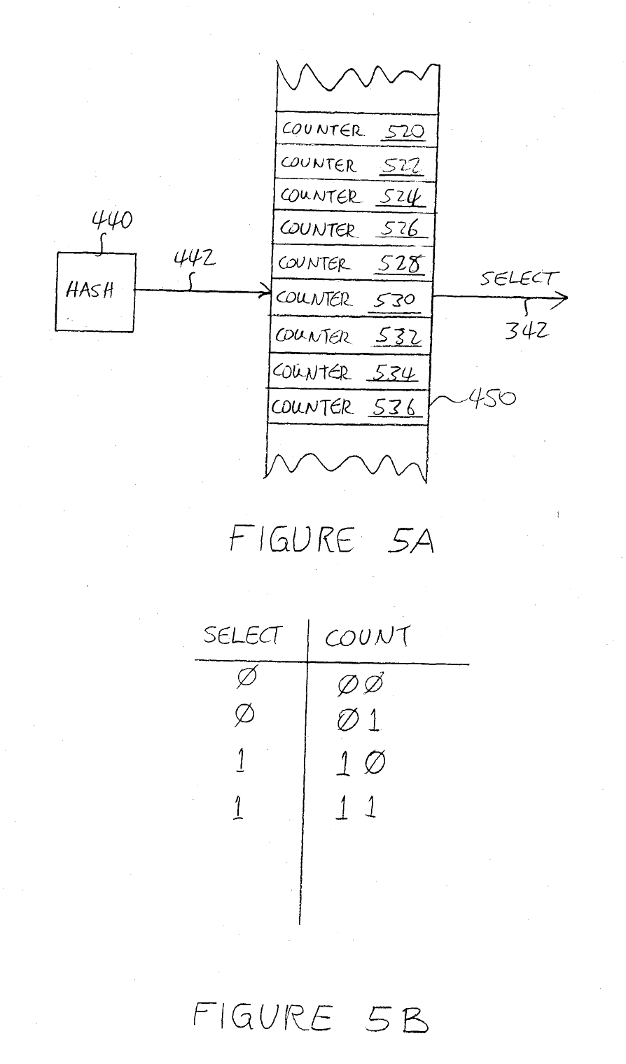

Referring now to FIG. 5A, a diagram of a state machine set 540 of FIG. 4 is shown, according to one embodiment of the present disclosure. In one embodiment, counters 520 through 536 are indexed by the index signal on index signal path 442 generated by hash logic 440. Here the counters 520 through 536 are shown as two-bit saturating counter. (A saturating counter is one in which incrementing the counter when its count is at its maximum value or decrementing the counter when its count is at its minimum value causes no change in count value.) In other embodiments, there could be more or fewer bits in the counter. The two bits may be concatenated as shown to give a select value based upon the count value.

Referring now to FIG. 5B, a logic table of counters 520 through 536 of FIG. 5A is shown, according to one embodiment of the present disclosure. Here the counters 520 through 536 are shown as two-bit saturating counters. In other embodiments, there could be more or fewer bits in the counter. If the count value is either 11 or 10, then the select value is 1, causing mux 330 to select the wrong-path branch outcome on recycled outcome signal path 312. If the count value is either 01 or 00, then the select value is 0, causing mux 330 to select the branch predictor's 320 prediction on prediction signal path 322. For embodiments with more bits in the counter, an extended form of concatenation may be used.

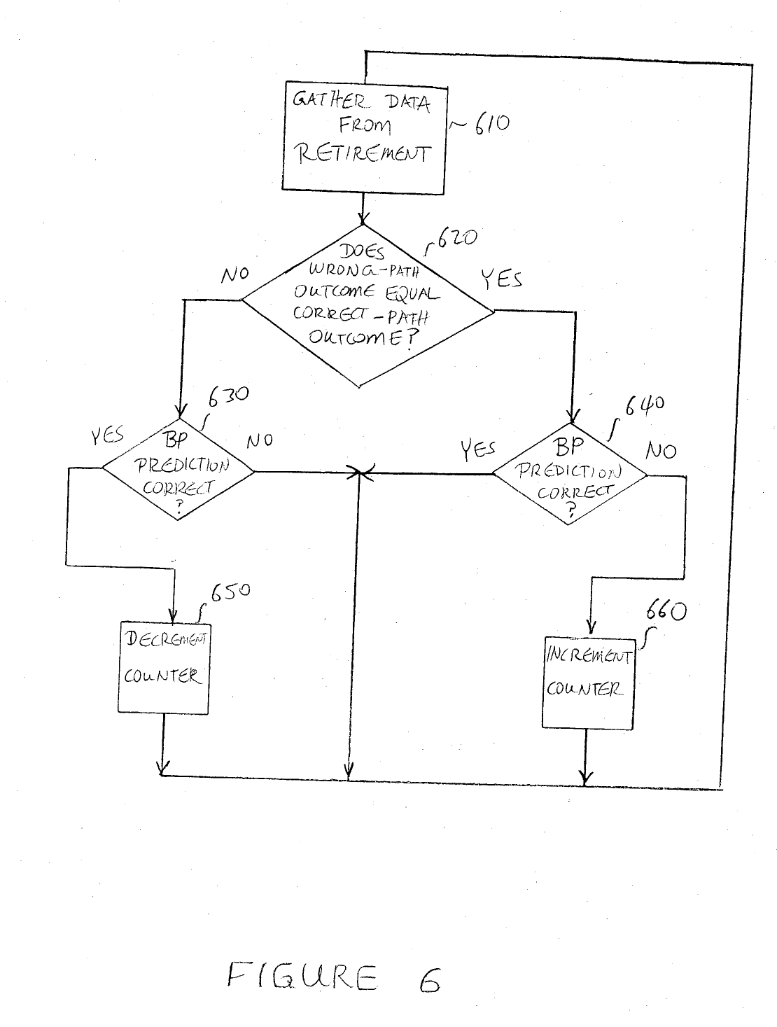

Referring now to FIG. 6, a flowchart of determining how to train a branch recycling predictor 340 is shown, according to one embodiment of the present disclosure. In block 610, the wrong-path branch outcome and correct-path branch outcome are gathered from an execution stage of a pipeline. Then in decision block 620, it may be determined whether the wrong-path branch outcome equals the correct-path branch outcome. If so, then the process exits via the YES path from decision block 620 and enters decision block 640. In decision block 640, it may be determined whether the corresponding branch predictor branch prediction was correct. If so, then no further action is taken. If not, then the process exits via the NO path and in block 660 the corresponding counter is incremented. In either case the process returns to block 610.

If, however, in decision block 620, it was determined that the wrong-path branch outcome did not equal the correct-path branch outcome, then the process exits via the NO path from decision block 620 and enters decision block 630. In decision block 630, it may be determined whether the corresponding branch predictor branch prediction was correct. If so, then the process exits via the NO path and in block 650 the corresponding counter is decremented. If so, then no further action is taken. In either case the process returns to block 610.

The individual actions shown in FIG. 6 are for the purpose of illustration. In other embodiments, the order of the individual actions may vary. In yet other embodiments, the individual actions may be different tests to determine the correlation of the previous wrong-path branch outcomes with the previous correct-path branch outcomes.

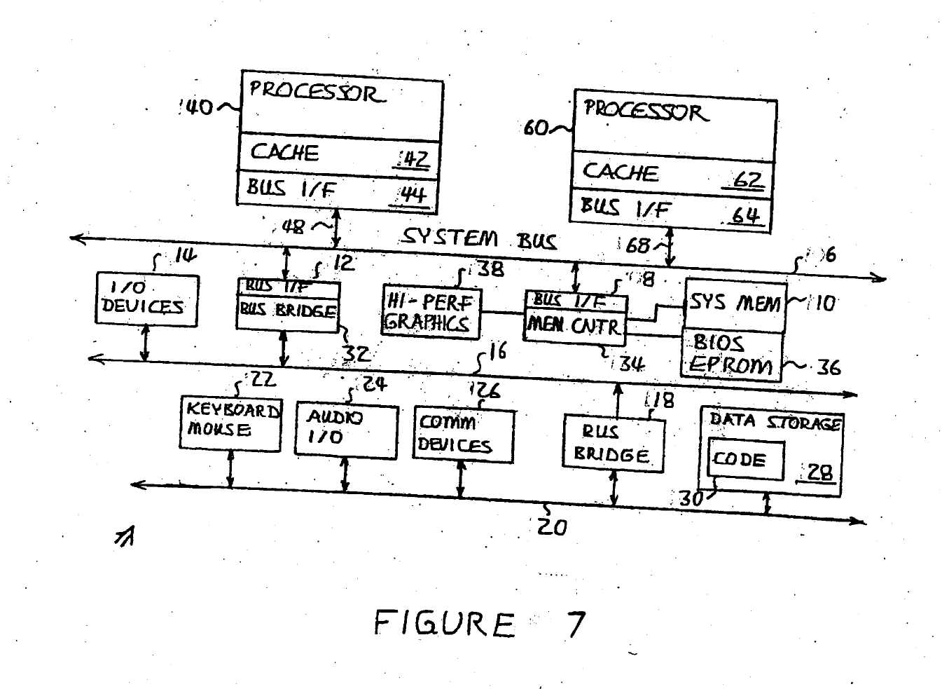

Referring now to FIG. 7, a schematic diagram of a microprocessor system is shown, according to one embodiment of the present disclosure. The FIG. 7 system may include several processors of which only two, processors 40, 60 are shown for clarity. Processors 40, 60 may be the processor 100 of FIG. 1, including the branch outcome recycling circuit of FIG. 3. Processors 40, 60 may include caches 42, 62. The FIG. 7 multiprocessor system may have several functions connected via bus interfaces 44, 64, 12, 8 with a system bus 6. In one embodiment, system bus 6 may be the front side bus (FSB) utilized with Pentium 4® class microprocessors manufactured by Intel® Corporation. A general name for a function connected via a bus interface with a system bus is an “agent”. Examples of agents are processors 40, 60, bus bridge 32, and memory controller 34. In some embodiments memory controller 34 and bus bridge 32 may collectively be referred to as a chipset. In some embodiments, functions of a chipset may be divided among physical chips differently than as shown in the FIG. 7 embodiment.

Memory controller 34 may permit processors 40, 60 to read and write from system memory 10 and from a basic input/output system (BIOS) erasable programmable read-only memory (EPROM) 36. In some embodiments BIOS EPROM 36 may utilize flash memory. Memory controller 34 may include a bus interface 8 to permit memory read and write data to be carried to and from bus agents on system bus 6. Memory controller 34 may also connect with a high-performance graphics circuit 38 across a high-performance graphics interface 39. In certain embodiments the high-performance graphics interface 39 may be an advanced graphics port AGP interface, or an AGP interface operating at multiple speeds such as 4×AGP or 8×AGP. Memory controller 34 may direct read data from system memory 10 to the high-performance graphics circuit 38 across high-performance graphics interface 39.

Bus bridge 32 may permit data exchanges between system bus 6 and bus 16, which may in some embodiments be a industry standard architecture (ISA) bus or a peripheral component interconnect (PCI) bus. There may be various input/output I/O devices 14 on the bus 16, including in some embodiments low performance graphics controllers, video controllers, and networking controllers. Another bus bridge 18 may in some embodiments be used to permit data exchanges between bus 16 and bus 20. Bus 20 may in some embodiments be a small computer system interface (SCSI) bus, an integrated drive electronics (IDE) bus, or a universal serial bus (USB) bus. Additional I/O devices may be connected with bus 20. These may include keyboard and cursor control devices 22, including mice, audio I/O 24, communications devices 26, including modems and network interfaces, and data storage devices 28. Software code 30 may be stored on data storage device 28. In some embodiments, data storage device 28 may be a fixed magnetic disk, a floppy disk drive, an optical disk drive, a magneto-optical disk drive, a magnetic tape, or non-volatile memory including flash memory.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. An apparatus, comprising:
a branch predictor trained by a processor to produce a branch prediction;
a branch recycle cache to store a current wrong-path branch outcome; and
a branch recycling predictor to select between said branch prediction and said current wrong-path branch outcome based upon correlation between a previous wrong-path branch outcome and a previous correct-path branch outcome.

2. The apparatus of claim 1, wherein said branch recycling cache is addressed by a candidate branch program counter.

3. The apparatus of claim 1, wherein said branch recycling predictor includes a set of state machines.

4. The apparatus of claim 3, wherein said branch recycling predictor to store a branch history.

5. The apparatus of claim 4, wherein said branch recycling predictor is to offset a mispredicted branch program counter to form an offset mispredicted branch program counter.

6. The apparatus of claim 5, wherein said branch recycling predictor is to hash said branch history, said offset mispredicted branch program counter, and a candidate branch program counter to index said set of state machines.

7. The apparatus of claim 6, wherein said hash is exclusive or.

8. The apparatus of claim 3, wherein said set of state machines is a set of counters.

9. The apparatus of claim 8, wherein one of said set of counters is to increment when said previous wrong-path branch outcome equals said previous correct-path branch outcome.

10. The apparatus of claim 9, wherein said increment is responsive to when said previous wrong-path branch outcome was mispredicted by said branch predictor.

11. The apparatus of claim 8, wherein one of said set of counters is to decrement when said previous wrong-path outcome does not equal said previous correct-path branch outcome.

12. The apparatus of claim 11, wherein one of said set of counters is further to decrement when said previous wrong-path outcome was correctly predicted by said branch predictor.

13. A method, comprising:
determining whether there is a positive correlation between a previous wrong-path branch outcome and a previous correct-path branch outcome;
storing a current wrong-path branch outcome; and
selecting said current wrong-path branch outcome if there is said positive correlation.

14. The method of claim 13, wherein said selecting includes selecting between said current wrong-path branch outcome and a branch prediction.

15. The method of claim 13, wherein said previous wrong-path branch outcome was determined by a speculative execution of a processor.

16. The method of claim 13, wherein said previous correct-path branch outcome was determined by a non-speculative execution of a processor.

17. The method of claim 13, wherein said current wrong-path branch outcome was determined by a speculative processor execution.

18. The method of claim 13, wherein said determining includes indexing a state machine by hashing a candidate branch program counter value with an offset mispredicted branch program counter value and with a branch history.

19. The method of claim 13, wherein said determining includes incrementing a state machine if said previous wrong-path branch outcome equals said previous correct-branch branch outcome.

20. The method of claim 19, wherein said determining further includes incrementing said state machine if a branch prediction for said previous correct-branch branch outcome was incorrect.

21. The method of claim 13, wherein said determining includes decrementing a state machine if said previous wrong-path branch outcome does not equal said previous correct-branch branch outcome.

22. The method of claim 21, wherein said determining further includes decrementing said state machine if a branch prediction for said previous correct-branch branch outcome was correct.

23. An apparatus, comprising:
means for determining whether there is a positive correlation between a previous wrong-path branch outcome and a previous correct-path branch outcome;
means for storing a current wrong-path branch outcome; and
means for selecting said current wrong-path branch outcome if there is said positive correlation.

24. The apparatus of claim 23, wherein said means for selecting includes means for selecting between said current wrong-path branch outcome and a branch prediction.

25. The apparatus of claim 23, wherein said means for determining includes means for indexing a state machine by hashing a candidate branch program counter value with the concatenation of a mispredicted branch program counter value and a branch history.

26. The apparatus of claim 23, wherein said means for determining includes means for incrementing a state machine if said previous wrong-path branch outcome equals said previous correct-branch branch outcome.

27. The apparatus of claim 26, wherein said means for determining further includes means for incrementing said state machine if a branch prediction for said previous correct-branch branch outcome was incorrect.

28. The apparatus of claim 23, wherein said means for determining includes means for decrementing a state machine if said previous wrong-path branch outcome does not equal said previous correct-branch branch outcome.

29. The method of claim 28, wherein said means for determining further includes means for decrementing said state machine if a branch prediction for said previous correct-branch branch outcome was correct.

30. A system, comprising:
a processor including a branch predictor trained by a processor to produce a branch prediction, a branch recycle cache to store a current wrong-path branch outcome, and a branch recycling predictor to select between said branch prediction and said current wrong-path branch outcome based upon correlation between a previous wrong-path branch outcome and a previous correct-path branch outcome;
a system bus coupled to said processor; and
an audio input/output circuit coupled to said system bus.

31. The system of claim 30, wherein said branch recycling cache is addressed by a candidate branch program counter.

32. The system of claim 30, wherein said branch recycling predictor includes a set of state machines.

33. The system of claim 32, wherein said branch recycling predictor to store a branch history.

34. The system of claim 33, wherein said branch recycling predictor is to hash a candidate branch program counter value with a branch history and with an offset mispredicted branch program counter.

35. The system of claim 32, wherein said set of state machines is a set of counters.

36. The system of claim 35, wherein one of said set of counters is to increment when said previous wrong-path branch outcome equals said previous correct-path branch outcome.

37. The system of claim 36, wherein one of said set of counters is further to increment when said previous wrong-path branch outcome was mispredicted by said branch predictor.
